(19) United States
(12) Patent Application Publication
(10) Pub. No.: US 2007/0255800 A1
(43) Pub. Date: Nov. 1, 2007

(54) Automatic goodbye messages

(75) Inventors: Joseph T. Fletcher, Seattle, WA (US); Justin M. Maguire, Seattle, WA (US)

Correspondence Address: PERKINS COIE LLP/MSFT, P. O. BOX 1247, SEATTLE, WA, 98111-1247, US

(73) Assignee: Microsoft Corporation, Redmond, WA (US)

(21) Appl. No.: 11/413,226

(22) Filed: Apr. 28, 2006

(51) Int. Cl. G06F 15/16

(52) U.S. Cl. 709/217

(57) ABSTRACT

A facility is described for automatically sending goodbye messages. In various embodiments, the facility receives an indication to terminate a conversation session that was previously established to exchange messages with a converser. The facility then retrieves a goodbye message, sends the goodbye message to the converser, and terminates the conversation session.

### BACKGROUND

Various “real-time” messaging systems are available, such as Instant Messenger, Chat, Voice over Internet Protocol (VOIP), and so forth, that enable users to communicate with each another in near real-time. As an example, a user can quickly and easily converse with another user over a wide geographic expanse using such a messaging system. Real-time messaging systems are provided by various software vendors, Internet service providers, and others.

Use of such messaging systems has grown in popularity. A messaging system can be used not only as a social interaction tool, but also as a business tool that sometimes obviates the need to meet someone in person, locate a telephone, or perform other non-electronic interactions with other people. People who desire to communicate quickly with others without relying on a telephone or waiting for an electronic mail exchange to occur commonly employ real-time messaging systems. In fact, these types of messaging systems have become so commonplace that they are provided as a component of operating systems, such as in the MICROSOFT WINDOWS operating system. Examples of commonly employed versions of real-time messaging systems are MICROSOFT WINDOWS MESSENGER and MICROSOFT OFFICE COMMUNICATOR.

Users generally use these real-time messaging systems to establish conversation sessions in which they exchange messages with other people. The messages can be part of a quick exchange or a long and drawn out conversation. Examples of messages are text and voice.

Ending a conversation without first sending an appropriate communication or other content can sometimes be misunderstood by a converser with whom a conversation is ended. As an example, a converser may be insulted when the user terminates a conversation without saying goodbye or may consider it to be rude to end a conversation abruptly without a communication that the conversation is ending. However, in some cultures, it can be difficult to provide such language to end a conversation. As an example, in some cultures it can be difficult to say goodbye to another person. Users who are in a rush may also find it difficult to end a conversation politely. Moreover, because messaging systems are generally textual, it can be difficult to provide other visual or auditory cues that humans generally provide when they converse in person.

### SUMMARY

A facility is described for enabling users to automatically send a goodbye message when ending a conversation with a converser. A converser is another person with whom the user is conversing. A user can configure a messaging application to store a goodbye message having various types of content, such as in textual, graphical, iconic, or even multimedia (e.g., including voice or video). When the user terminates a conversation with the converser, such as by closing a conversation window of the messaging application, the facility automatically sends the goodbye message to the converser. The user can configure the messaging application with multiple goodbye messages, such as to personalize goodbye messages based on conversers, select goodbye messages based on time of day or randomly, and so forth. Then, when the user terminates a conversation, the facility selects a goodbye message for sending.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1A is a block diagram illustrating an example of a suitable computing environment in which the facility may operate.

FIG. 1B is a block diagram illustrating a storage device of FIG. 1A in further detail.

FIG. 2 is a block diagram illustrating an example of a suitable environment in which the facility may operate in some embodiments.

FIGS. 3-6 are display diagrams illustrating aspects of a user interface provided by the facility in various embodiments.

FIG. 7 is a flow diagram illustrating a send_message routine invoked by the facility in some embodiments.

### DETAILED DESCRIPTION

A facility is described for enabling users to automatically send a goodbye message when ending a conversation with a converser, such as by terminating a conversation session. A converser is another person with whom the user is conversing. In some embodiments, a user can configure a messaging application to store a goodbye message. The goodbye message can be textual, graphical, iconic, or even contain multimedia (e.g., including voice or video) elements. When the user terminates a conversation with the converser, such as by closing a conversation window of the messaging application, the facility automatically sends the goodbye message to the converser. As an example, upon completing a conversation using messaging applications, users generally close a conversation window or the messaging application's main window. Prior to closing the messaging window or main window, users can type in a goodbye message so that the converser with whom the user is corresponding knows that the user is terminating the conversation. When it is difficult to end the conversation, or if the user is in a rush, the user may merely close the window without politely ending the conversation with a goodbye message. In such a case, the facility automatically sends the goodbye message when the facility is configured to do so.

In some embodiments, the user can configure the messaging application to store multiple goodbye messages, such as to personalize goodbye messages based on conversers, select goodbye messages based on the time of day or randomly, and so forth. Then, when the user terminates a conversation, the facility selects a goodbye message for sending. As an example, the facility may select a goodbye message based on the identity of the converser. As another example, the facility may select a goodbye message randomly. As another example, the facility may select a goodbye message based on other aspects of the conversation, such as time of day, length of conversation, mood indicated by the user, and so forth. Examples of such goodbye messages are: “Have a great afternoon!”; “Sorry, I have got to go!”; “Have a terrific day!”; and “Ciao, Harry!”

In some embodiments, the user can configure the facility to select and send goodbye messages with which the facility is preconfigured. As an example, the facility may be preconfigured with one or more standard goodbye messages. When the user configures the facility to send a preconfigured message automatically, the user may not need to provide a goodbye message that the facility stores.

The user can configure the facility by using a user interface for providing goodbye messages. As an example, the user can type in a goodbye message. As another example, the user can speak a goodbye message into a microphone. As another example, the user can indicate an image or provide a video to send as a portion of a goodbye message. Then, when the user ends a conversation, a goodbye message can be selected and sent to the converser's messaging application for display or playback on the converser's computer.

By automatically sending goodbye messages, the user can avoid any cultural or other difficulties in ending a conversation, or can save time.

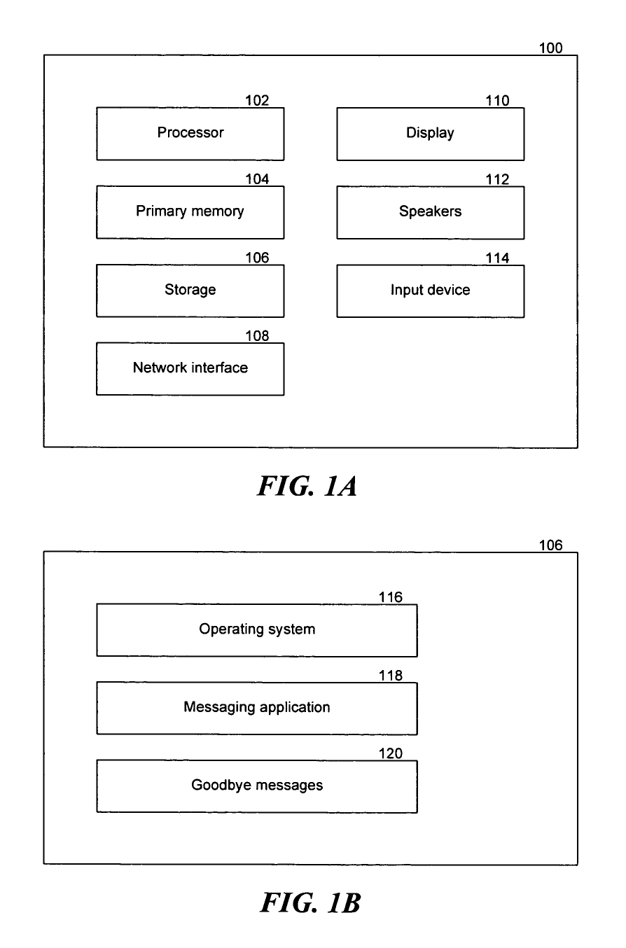

Turning now to the figures, FIG. 1A is a block diagram illustrating an example of a suitable computing environment 100 in which the facility may be implemented. A system for implementing the facility includes a general purpose computing device in the form of the computing system 100 (“computer”). Components of the computer may include, but are not limited to, a processing unit 102, a system primary memory 104, a storage unit 106, a network interface 108, a display 110, one or more speakers 112, and an input device 114.

The computer 100 typically includes a variety of computer-readable media that are operable with the storage 106. Computer-readable media can be any available media that can be accessed by the computer 100 and include both volatile and nonvolatile media and removable and nonremovable media.

The computer 100 may operate in a networked environment using logical connections to one or more remote computers. A remote computer may be a personal computer, a server, a router, a network PC, a peer device, or other common network node, and typically includes many or all of the elements described above in relation to the computer 100. A logical connection can be made via a local area network (LAN) or a wide area network (WAN), but may also include other networks. Such networking environments are commonplace in homes, offices, enterprisewide computer networks, intranets, and the Internet. The computer 100 can be connected to a network through a network interface or adapter 108, such as to a wired or wireless network.

The computer 100 is only one example of a suitable computing environment and is not intended to suggest any limitation as to the scope of use or functionality of the facility. Neither should the computing system environment be interpreted as having any dependency or requirement relating to any one or a combination of the illustrated components.

The facility is operational with numerous other general purpose or special purpose computing system environments or configurations. Examples of well-known computing systems, environments, and/or configurations that may be suitable for use with the facility include, but are not limited to, personal computers, server computers, handheld or laptop devices, cellular telephones, tablet devices, multiprocessor systems, microprocessor-based systems, set-top boxes, programmable consumer electronics, network PCs, minicomputers, mainframe computers, distributed computing environments that include any of the above systems or devices, and the like.

The facility may be described in the general context of computer-executable instructions, such as program modules, that are executed by a computer. Generally, program modules include routines, programs, objects, components, data structures, and so forth that perform particular tasks or implement particular abstract data types. The facility may also be employed in distributed computing environments where tasks are performed by remote processing devices that are linked through a communications network. In a distributed computing environment, program modules may be located in local and/or remote computer storage media, including memory storage devices.

FIG. 1B is a block diagram illustrating a storage device of FIG. 1A in further detail. According to the illustrated embodiment, the storage device stores an operating system 116, a messaging application program 118, and one or more goodbye messages 120. The goodbye messages can be stored in files, in a registry, or in any location from which the messaging application program can retrieve data. The storage device may also store other application programs and data (not illustrated).

While various functionalities and data are shown in FIGS. 1A and 1B as residing on particular computer systems that are arranged in a particular way, those skilled in the art will appreciate that such functionalities and data may be distributed in various other ways across computer systems in different arrangements. While computer systems configured as described above are typically used to support the operation of the facility, one of ordinary skill in the art will appreciate that the facility may be implemented using devices of various types and configurations, and having various components.

The techniques may be described in the general context of computer-executable instructions, such as program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

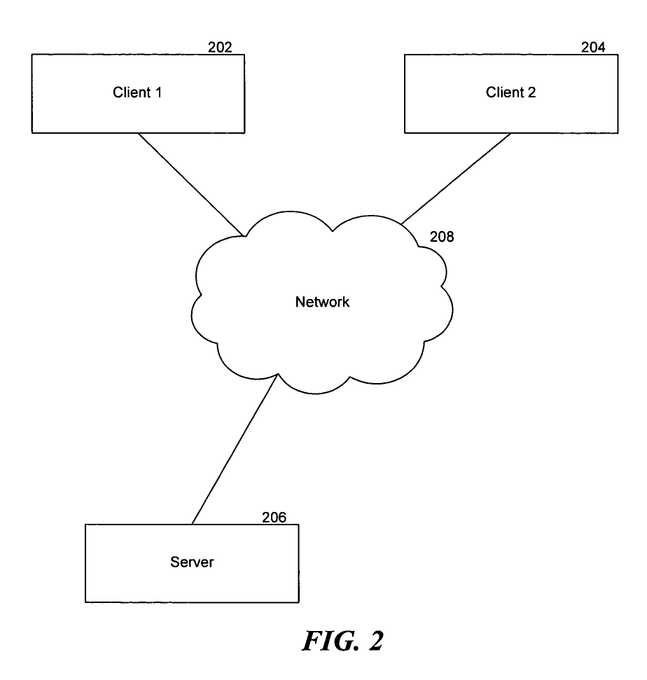

FIG. 2 is a block diagram illustrating an example of a suitable environment in which the facility may operate in some embodiments. The environment has two client computers 202 and 204. The client computers may communicate with each other via a network 208. As an example, client 1 (202) may communicate a message input by a user into a messaging application to a server computer 206 via the network, which then communicates the message to client 2 (204). The server computer may be executing a server portion of the messaging application. The network 208 can be an intranet, the Internet, or a combination of multiple networks. In various embodiments, the environment may have additional client or server computers.

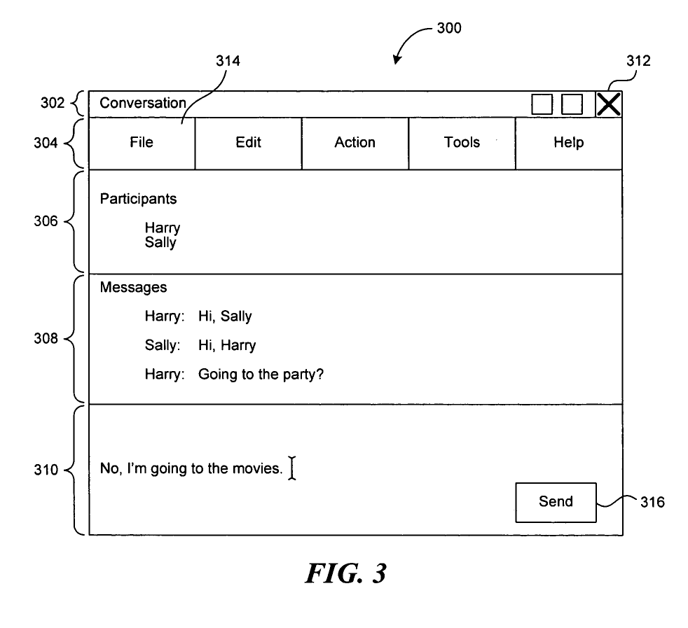

FIGS. 3-6 are block diagrams illustrating aspects of a user interface provided by the facility in various embodiments. While some functionality of the software components or user interface is described below, the software components or user interface may also provide other functionality that is not specifically described.

According to the embodiment illustrated in FIG. 3, a main window of a messaging application 300 has a title region 302, a menu region 304, a participants region 306, a messages region 308, and a message input region 310.

The title region indicates a title of the conversation window or messaging application. As an example, the title region can indicate that the user is engaged in a conversation. The title region may also have various icons for manipulating the messaging application, such as a close button 312 which, when selected, will cause the window to close and the conversation session to terminate.

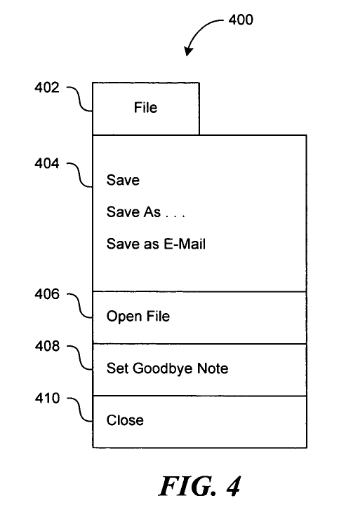

The menu region provides a menu for the user to use to manipulate the messaging application. As an example, the menu region provides a File menu option 314, which is described in further detail below in relation to FIG. 4.

The participants region indicates a list of people with whom the user is conversing. In some embodiments, the list includes conversers. In other embodiments, the list indicates the user and conversers. In various embodiments, the region further indicates a status associated with the listed people, such as online, offline, out to lunch, busy, and so forth. In the illustrated embodiment, Harry and Sally are involved in a conversation.

The messages region provides a history of messages sent or received in the conversation session. In the illustrated example, Harry and Sally have exchanged three messages—two from Harry and one from Sally.

The user can type in a message in the input region. In the illustrated example, the user has typed in “No, I'm going to the movies.” A cursor indication at the end of this message indicates a position where further input would be entered, if typed in.

The input region may also have a Send button region 316 that, when selected, would cause the messaging application to send the input message to others in the conversation session. In the illustrated example, the message “No, I'm going to the movies” would be sent.

The input region (or other portions of the messaging application) may have additional buttons or regions to provide other input, such as voice, sounds, images, video, and so forth.

FIG. 4 is a display diagram illustrating a File menu 400 associated with the messaging application illustrated in FIG. 3 and described above. The File menu option 402 has a save region 404, open region 406, set goodbye note region 408, and a close region 410. These regions provide one or more commands to a user that, when selected, cause the messaging application to perform various functions.

The save region provides commands for saving the conversation history, such as the history of messages in the messages region 308.

The open region provides commands for retrieving a conversation history, opening a file to send to another user in the conversation session, and so forth.

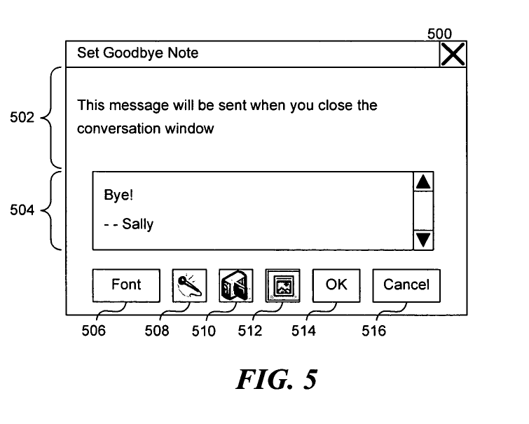

The set goodbye note region 408 provides a command that causes a user interface to display that the user can employ to provide a goodbye note. This user interface is illustrated in FIG. 5 and described in further detail below. In some embodiments, the set goodbye note region may also provide commands to enable the user (1) to indicate whether or not a goodbye note should be automatically sent when the user terminates a conversation or (2) to display a user interface for selecting one of a number of preconfigured goodbye messages. The goodbye note region may also provide other related commands.

The close region provides a close command that closes the messaging application and terminates the conversation session. In some embodiments, this command provides the same behavior as when the close button 312 is selected.

FIG. 5 is a display diagram illustrating a user interface that enables a user to provide a goodbye note. The user interface has a close button 500 that, when selected, will close the user interface. If the user has changed any settings, such as in edit region 504, the user may be prompted to save the changes.

The user interface has a text region 502 that provides instructions relating to the user interface. As an example, the text region indicates that a goodbye message entered by the user into the input region will be sent when the conversation window is closed.

Input region 504 is populated with a message that the user has entered, such as when previously configuring the facility. The user can enter text in the input region to indicate a goodbye message that the facility stores for sending later, such as when a conversation terminates.

The facility may also provide options relating to the goodbye message in various embodiments. As an example, the user interface provides a Font button 506 for setting a font for the goodbye message, or portions thereof. A microphone button 508 enables a user to speak a message, record a sound, attach a sound file, and so forth. This sound or speech would then be transmitted when the conversation is closed. As another example, the user interface provides a camcorder button 510 that, when selected, enables the user to attach a movie or other multimedia file to the goodbye message. An image button 512 enables the user to attach an image to the goodbye message. An OK button 514, when selected, saves the user's changes and closes the user interface. A cancel button 516, when selected, ignores the user's changes and closes the user interface.

In some embodiments, the user interface may also enable the user to indicate whether the goodbye message should be sent to one or more identified converser identities, at particular times of the day, randomly, and so forth. The facility can store this information in a file, registry, database, or other storage.

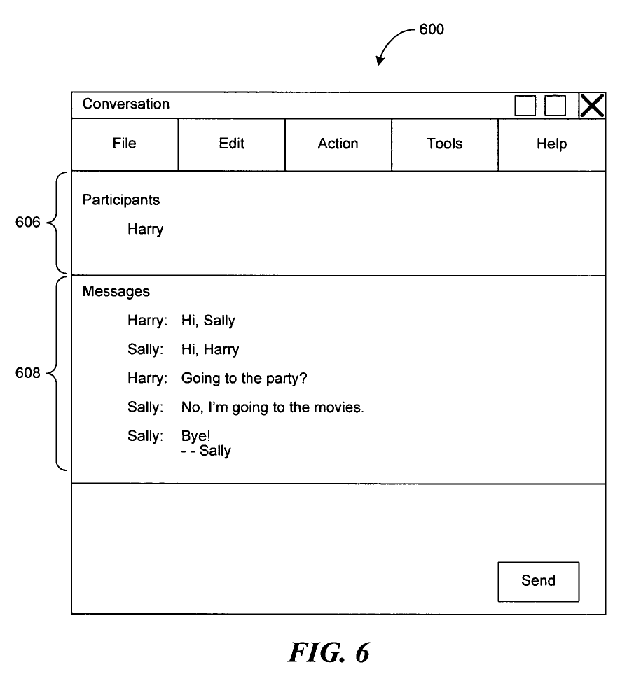

FIG. 6 is a display diagram illustrating the main window of the messaging application illustrated in FIG. 3 and discussed above. However, according to the illustrated messaging application main window 600, Sally has left the conversation, as is indicated by the absence of that name in participants region 606. Sally's goodbye message is added to the messages region 608 by the facility when Sally terminates the conversation session. This goodbye message was previously provided by Sally using the user interface illustrated in FIG. 5.

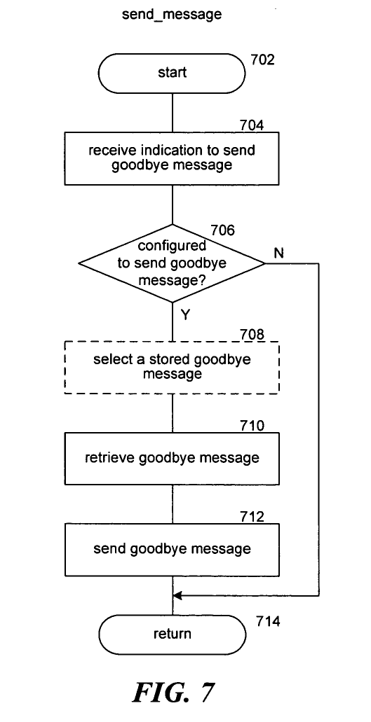

FIG. 7 is a flow diagram illustrating a send_message routine invoked by the facility in some embodiments. The send_message routine sends a goodbye message when a conversation session terminates. The routine begins at block 702.

At block 704, the routine receives an indication to send a goodbye message. As an example, the routine may receive the indication when the user closes the messaging application's main window or a conversation window.

At decision block 706, the routine determines whether the facility is configured to send a goodbye message automatically. As an example, the routine may determine whether a goodbye message is stored. Alternatively, the routine may determine whether an option has been turned on to send a goodbye message automatically. When the facility is configured to send a goodbye message automatically, the routine continues at block 708. Otherwise, the routine continues at block 714, where it returns.

At block 708, the routine optionally selects a stored goodbye message. As an example, when the facility is configured or preconfigured with multiple goodbye messages, the facility selects one of the multiple goodbye messages. The facility may select a goodbye message randomly, based on the identity of converser with whom the user is conversing, time of day, or other attributes of the conversation.

In some embodiments, the facility is configured with a single goodbye message. In such a case, the logic of block 708 is ignored and the routine continues at block 710 after executing the logic of decision block 706 and determining that the facility is configured to send a goodbye message automatically.

At block 710, the routine retrieves a goodbye message. In embodiments in which the facility is configured to use only a single goodbye message, the facility retrieves the stored goodbye message. Otherwise, the facility retrieves the goodbye message selected at block 708.

At block 712, the routine sends the goodbye message. As previously discussed, the goodbye message can include text, graphics, video, sound, and any other type of content. When the goodbye message is sent, the messaging application employed by the converser displays or renders the content it receives.

At block 714, the routine returns.

Upon completion of the send_message routine, the facility terminates they conversation session.

The facility can be used with VOIP, videoconferencing, or other communications means to send various communications, including good bye messages, out of office messages, contact information, and so forth.

Those skilled in the art will appreciate that the blocks illustrated in FIG. 7 and described above may be altered in a variety of ways. For example, the order of the blocks and their associated logic may be rearranged, additional logic may be performed in parallel, shown blocks may be omitted, or other blocks and associated logic may be included, and so forth.

From the foregoing, it will be appreciated that specific embodiments of the invention have been described herein for purposes of illustration, but that various modifications may be made without deviating from the spirit and scope of the invention. As an example, the facility may be employed with instant messaging, chat, VOIP, and so forth. As a further example, the goodbye message may be sent by a user explicitly, such as by invoking a command. Accordingly, the invention is not limited except as by the appended claims. As another example, each participant computer could receive data relating to the regions and draw the regions.

1. A method performed by a computer system for sending a goodbye message, comprising:
receiving an indication to terminate a conversation session, the conversation session previously established to exchange messages with a converser;
determining whether a goodbye message should be sent; and
when the goodbye message should be sent,
selecting a goodbye message from a set of goodbye messages;
retrieving the selected goodbye message;
sending the selected goodbye message to the converser; and
terminating the conversation session.

2. The method of claim 1 wherein the receiving includes receiving an indication to close a main window of a messaging application.

3. The method of claim 1 wherein the receiving includes receiving an indication to close a conversation window of a messaging application.

4. The method of claim 1 wherein the determining includes determining whether a goodbye message is stored.

5. The method of claim 1 wherein the determining includes determining whether an option has been set to send a goodbye message.

6. The method of claim 1 wherein the selecting includes selecting a goodbye message from the set of goodbye messages randomly.

7. The method of claim 1 wherein the selecting includes selecting a goodbye message from the set of goodbye messages based on an identity of the converser.

8. The method of claim 1 wherein the selecting includes selecting a goodbye message from the set of goodbye messages based on a time of day when the goodbye message is sent.

9. A computer-readable medium having computer-executable instructions that, when executed, cause a computer system to perform a method for sending a goodbye message, the method comprising:
receiving an indication to terminate a conversation session, the conversation session previously established to exchange messages with a converser;
retrieving a goodbye message;
sending the goodbye message to the converser; and
terminating the conversation session.

10. The computer-readable medium of claim 9 wherein the receiving includes receiving an indication to close a main window of a messaging application.

11. The computer-readable medium of claim 9 wherein the receiving includes receiving an indication to close a conversation window of a messaging application.

12. The computer-readable medium of claim 9 further comprising determining whether to send a goodbye message.

13. The computer-readable medium of claim 9 further comprising selecting a goodbye message from a list of multiple goodbye messages.

14. The computer-readable medium of claim 9 wherein the goodbye message contains multimedia content.

15. The computer-readable medium of claim 9 wherein the goodbye message was provided by a user.

16. The computer-readable medium of claim 9 wherein the goodbye message was preconfigured.

17. A system for sending a goodbye message, comprising:
a storage component that stores a goodbye message; and
a messaging application that receives from a user a goodbye message, stores the goodbye message in the storage component and, upon receiving an indication to terminate a conversation session, retrieves the stored goodbye message from the storage component, sends the retrieved goodbye message, and terminates the conversation session.

18. The system of claim 17 wherein the messaging application receives an indication to terminate the conversation session when a conversation window is requested to be closed.

19. The system of claim 17 wherein the messaging application receives an indication to terminate the conversation session when a main window of the messaging application is requested to be closed.

20. The system of claim 17 wherein the goodbye message is sent without any user interaction.
